(19) United States
(12) Patent Application Publication
(10) Pub. No.: US 2018/0275687 A1
(43) Pub. Date: Sep. 27, 2018

(54) SPIRAL SPRING FLOW REGULATOR

(71) Applicant: FLUIDMASTER, INC., San Juan Capistrano, CA (US)

(72) Inventor: Joseph HAN, Irvine, CA (US)

(73) Assignee: FLUIDMASTER, INC., San Juan Capistrano, CA (US)

(21) Appl. No.: 15/934,743

(22) Filed: Mar. 23, 2018

Related U.S. Application Data
(60) Provisional application No. 62/475,707, filed on Mar. 23, 2017.

(51) Int. Cl. G05D 7/01; E03B 7/07; E03B 7/02; G05D 16/16; F16K 17/30; F16K 17/04

(52) U.S. Cl. CPC G05D 7/0153; E03B 7/075; F16K 17/048; G05D 16/163; F16K 17/30; E03B 7/02

(57) ABSTRACT

Some embodiments include a flow regulator with a main body dimensioned to be received within a flow passageway that includes an inlet and an adjustable outlet. Further, some embodiments include an inner chamber positioned in the main body extending from at least proximate the inlet of the main body along at least a partial length of the main body and positioned as an upstream section. Some embodiments include a compressible or expandable extending vane extending from the main body and extending around the inner chamber. Some further embodiments include an adjustable fluid flow space extending around or over at least a portion of the extended vane that is configured to receive at least some fluid from at least a portion of the flow passageway, where the fluid comprises a fluid flow rate and a fluid pressure.

### RELATED APPLICATIONS

This application claims priority to U.S. provisional application Ser. No. 62/475,707, filed on Mar. 23, 2017, the entire contents of which are incorporated herein by reference.

### BACKGROUND

It is common for water pressure and flow rates in supply lines to vary across different geographic regions, including across one country or state. Accordingly, even if identical fill valves are installed in different regions, the volume, flow rate and pressure of incoming water can vary drastically. The resulting inconsistency is undesirable particularly when excessive water pressure and/or flow rates lead to waste of water resources, and undesirable levels of refilling noise.

Thus, there exists a need for a technology that would moderate the fluid flow rate through the valve to maintain a constant flow and control fluid use, and to reduce refilling noise. Ideally, the technical solution should be relatively small, and inexpensive to manufacture, without the need to include additional components or hardware in the tank or fill valve, and should not need to be accessed or adjusted by a user during any time during the life of the device.

### SUMMARY

Some embodiments include a flow regulator comprising a main body dimensioned to be received within a flow passageway that includes at least one inlet and at least one adjustable outlet. Further, some embodiments include an inner chamber positioned at least partially within the main body and extending from at least proximate the at least one inlet of the main body along at least a partial length of the main body and positioned as an upstream section. Some embodiments include a compressible or expandable extending vane extending from the main body and extending around at least a portion of the inner chamber. Some further embodiments include an adjustable fluid flow space extending around or over at least a portion of the extended vane that is configured to receive at least some fluid from at least a portion of the flow passageway, where the fluid comprises a fluid flow rate and a fluid pressure.

Some embodiments include an inner chamber that is positioned substantially in the center of the main body, and the at least one inlet is positioned at a base of the main body. In some further embodiments, the extending vane extends outwardly from the inner chamber, and is longitudinally expandable or compressible based at least in part on the fluid pressure. In some embodiments, the adjustable fluid flow space is configurable to at least partially include or exclude a flow pathway from within at least a portion of the inner chamber based at least in part on the fluid pressure.

In some embodiments, the main body comprises an adjustable spiral wrapping around at least a portion of the inner chamber, where the adjustable spiral includes the compressible or expandable extending vane. In some embodiments, the inclusion or exclusion of the flow pathway is based at least in part on a state of expansion or compression of the extending vane, the expansion or compression of the extending vane being dependent at least in part on the fluid pressure.

In some embodiments, the extending vane comprises an inner edge portion extending from an upper surface of the extending vane, and extends generally in a spiral shape around at least a portion of the inner chamber. In some embodiments, the inner edge portion extends across a portion of the extending vane from adjacent the inner chamber radially outwards. In some embodiments, the extending vane further comprises a recess following a contour of at least a portion of the extending vane on a lower surface opposite the upper surface.

In some embodiments, based at least in part on the fluid pressure exerted on a portion of the main body, at least a portion of the inner edge portion is configured to be received into or out of the recess. In some further embodiments, based at least in part on the fluid pressure exerted on a portion of the main body, the adjustable fluid flow space at least partially includes a fluid flow through the inner chamber when the inner edge portion is positioned at least partially out of the recess.

In some embodiments, based at least in part on the fluid pressure exerted on a portion of the main body, the adjustable fluid flow space at least partially excludes a fluid flow through the inner chamber when the inner edge portion is positioned at least partially in the recess. In some embodiments, the fluid flow space is configured and arranged to change based on the fluid pressure, where the fluid pressure contributes to a movement of at least a portion of the main body including movement of the extending vane. In some other embodiments, at least one of the main body and extending vane comprises a flexible polymer, wherein at least a portion of the main body or extending vane is configured to exhibit flexing movement based at least in part on the fluid pressure.

Some embodiments include at least one adjustable outlet is configured to adjust the fluid flow rate in a downstream section of the flow passageway based at least in part on the fluid pressure experienced by the main body, where the fluid flow rate adjustment includes a holding substantially constant or decrease in flow rate in the downstream section based at least in part on an increase in the flow pressure in the upstream section. Further, an increase in flow pressure produces movement of the extending vane and at least partial closure of the at least one adjustable outlet between the inner chamber and the adjustable fluid flow space.

Some further embodiments of the invention include a flow system comprising at least one adjustable fluid outlet extending through an inner chamber of a main body, and an adjustable fluid flow space extending around at least a portion of the inner chamber, where the adjustable fluid flow space is reversible coupled to the inner chamber. Some embodiments include a compressible or expandable extending vane extending from the main body and wrapping around at least a portion of the inner chamber, where the adjustable fluid flow space is configured to enable a fluid flow extending around or over at least a portion of the extended vane. In some embodiments, based on a fluid pressure, the fluid flow is configured to receive fluid from the inner chamber when the at least one adjustable fluid outlet is fluidly coupled to the inner chamber.

Some other embodiments include at least one adjustable fluid outlet that is configured to adjust the fluid flow rate in a downstream section of a flow passageway based at least in part on the fluid pressure, where the fluid flow rate adjustment includes a holding substantially constant or decrease in flow rate in the downstream section based at least in part on an increase in the flow pressure in an upstream section, and where an increase in flow pressure produces movement of the extending vane and at least partial closure of the at least one adjustable fluid outlet.

Some embodiments include an extending vane comprising an inner edge portion extending from an upper surface of the extending vane, and extending spirally around at least a portion of the inner chamber. In some embodiments, the inner edge portion extends across a portion of the extending vane from adjacent the inner chamber radially outwards. In some further embodiments, the extending vane further comprises a recess positioned on a lower surface opposite the upper surface, where based at least in part on the fluid pressure, at least a portion of the inner edge portion is configured to be received into or out of the recess.

### DESCRIPTION OF THE DRAWINGS

FIG. 1 is a top perspective view of a flow regulator in accordance with some embodiments of the invention.

FIG. 2 is a bottom perspective view of the flow regulator of FIG. 1 in accordance with some embodiments of the invention.

FIG. 3 is a first side elevation view of the flow regulator of FIG. 1 in accordance with some embodiments of the invention.

FIG. 4 is a second side elevation view of the flow regulator of FIG. 1, rotated by 90 degrees from the position shown in FIG. 3 in accordance with some embodiments of the invention.

FIG. 5 is a first sectional side elevation view of the flow regulator of FIG. 1 in accordance with some embodiments of the invention.

FIG. 6 is a second sectional side elevation view of the flow regulator of FIG. 1, rotated by 90 degrees from the position shown in FIG. 5 in accordance with some embodiments of the invention.

FIG. 7 is a sectional illustration of the flow regulator of FIG. 1 in its relaxed open elongated state with the spiral flow pathway open in accordance with some embodiments of the invention.

FIG. 8 is a sectional illustration of the flow regulator of FIG. 1 in its compressed state with the spiral flow pathway closed in accordance with some embodiments of the invention.

FIG. 9 is a sectional illustration of the flow regulator of FIG. 1 positioned in a supply tube for a fluid refill valve in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

Some embodiments of the invention described herein can include a flow regulator or controller that can be used in any fluidic application where a generally constant flow is required over a range of different inlet pressures. As used herein, the term “fluid controller” and “fluid regulator” can be used interchangeably. Some embodiments of the invention include a flow regulator that can be used to reduce noise emissions of a refill valve for a tank or any fluid reservoir. It is to be understood, however, the embodiments of the invention described herein are not limited to fill valves, and can instead be used in a wide variety of other applications.

Some embodiments include a spiral spring-shaped flow regulator for use with a fluid fill valve or other fluidic element or structure. For example, some embodiments of the invention include a flow regulator that can be positioned within a flow tube or other fluid flow pathway. In some embodiments, the flow regulator can be made of a material that can flex and change shape based on the physical environment. For example, in some embodiments, the flow regulator can be made of an elastomeric material so that any portion of the flow regulator can change shape or move by either compressing, expanding, moving, or bending based on a pressure experienced by any portion of the flow regulator. In some embodiments, the change of shape or movement of the flow regulator can cause a change in at least a portion of a flow pathway adjacent to the surface of at least a portion of the flow regulator. In some embodiments, the change of shape or movement of the flow regulator can cause a change in a flow characteristics therethrough.

In some embodiments, the flow regulator can comprise a flexible or semi-flexible body with a flow pathway extending therethrough from one end to another end. In some embodiments, during use, as fluid pressure is increased at an upstream end of the flow regulator, at least some portions of the flow regulator can deform or move so that one or more flow pathways through the flow regulator change (e.g., such as shrink) such that the flow regulator can provide a generally constant rate of flow over a range of different pressures. In various optional embodiments, the flow regulator can itself be placed into an insert, and in some embodiments, relief portions of the flow regulator are cut away to permit the flow regulator to flex and thus provide improved flow characteristics (such as reducing the potential for shock waves). In one embodiment, the expansion of the flow pathway is non-linear. In other embodiments, the expansion is linear.

In some embodiments of the invention, at least a portion of one or more embodiments of the flow regulator described herein can comprise a polymer-based material including one or more homopolymers, one or more copolymers, or mixtures thereof. In some embodiments, the material can comprise an elastomeric polymer such as rubber or silicone. In some embodiments, the rubber can be a natural rubber (e.g., such as natural gum rubber), a synthetic rubber, or combinations thereof. In some embodiments of the invention, the material can comprise a butyl or butylene rubber, ethylene propylene diene monomer (EPDM) rubber, neoprene rubber, nitrile rubber, silicone rubber, a polyurethane rubber, a fluoro-silicone, chloroprene rubber, nitrile rubber, or combinations thereof. In some embodiments, the material can include recycled rubber. In some other embodiments, at least a portion of the flow regulator can comprise a thermoplastic such as polyethylene or polypropylene. In some embodiments, the flow regulator can comprise any convention polymer or polymer blend.

In some further embodiments of the invention, at least a portion of the flow regulator described herein can comprise a polymer-based matrix material including a dispersed or semi-dispersed secondary material. In some embodiments, the secondary material can influence the viscoelastic response of the material. For example, some embodiments include a material that can comprise one or more polymers infused with (or including a dispersion of) filler elements, filler compounds, and/or filler mixtures. For example, in some embodiments, at least a portion of the material can comprise a polymer-based matrix material including filaments or particles dispersed in a matrix to form a composite material. For example, some embodiments include a filler that can comprise a fibrous material. In some embodiments, at least a portion of the filler can be oriented in a preferred direction. In some other embodiments, the material can comprise a fiber-filled matrix material including natural or synthetic filaments dispersed in a matrix to form a fiber composite material. Some embodiments include a filler material that is at least partially dispersed through at least a portion of the material. In some embodiments, the filler material can be amorphous or crystalline, organic or inorganic material. In some other embodiments, the particle size of the filler material can be between 1-10 microns. In some other embodiments, at least some portion of the filler material can be sub-micron. In some other embodiments, at least a portion of the filler can comprise a nano-sized particle filler material.

Some embodiments include a flow regulator that can be used with a fluid fill valve or other fluidic element to regulate or control fluid flow from a fluid flow upstream of the fluid fill valve or other fluidic element, to a fluid flow downstream of the fluid fill valve or other fluidic element. For example, in operation, some embodiments include a flow regulator that can be positioned in a fluid supply tube through which fluid (e.g., such as water) flows into the base of the fill valve. However, alternative placements for the flow regulator are also contemplated in accordance with the scope of the invention.

In some embodiments, the flow regulator can comprise spiral spring-shaped flow regulator including an elongated spiral body. In some embodiments, the flow regulator can include an inner or internal chamber formed in the center of the elongated spiral body that has an opening at a base of the elongated spiral body, and an outwardly extending vane formed around the exterior of the elongated spiral body. In some embodiments, the elongated spiral body is longitudinally expandable to an expended position such that a spiral flow pathway opens in the elongated spiral body between the inner chamber and the exterior of the elongated spiral body. Moreover, in some embodiments, the elongated spiral can be longitudinally contractable to a contracted position such that the spiral flow pathway can be closed.

In some embodiments of the invention, during operation in a fluid-carrying pipe or other passageway, the flow regulator can include a spiral flow pathway that enlarges or opens between adjacent portions of the outwardly extending vanes at lower pressures, and reduces in size or closes at higher pressures. In operation, the spiral flow pathway provides a tortuous path for the fluid that lengthens the overall flow channel of the fluid, and increasing the energy losses along the walls of the path. In some embodiments, these wall losses are further increased by the energy required to constantly turn the water around the spiral structure. In this manner, energy losses resulting from the spiral structure can produce a significant pressure drop, and thereby can provide the pressure regulation desired. In some embodiments, this has the advantage of decreasing high-pressure flow through the supply tube, which also can potentially reduce flow noise.

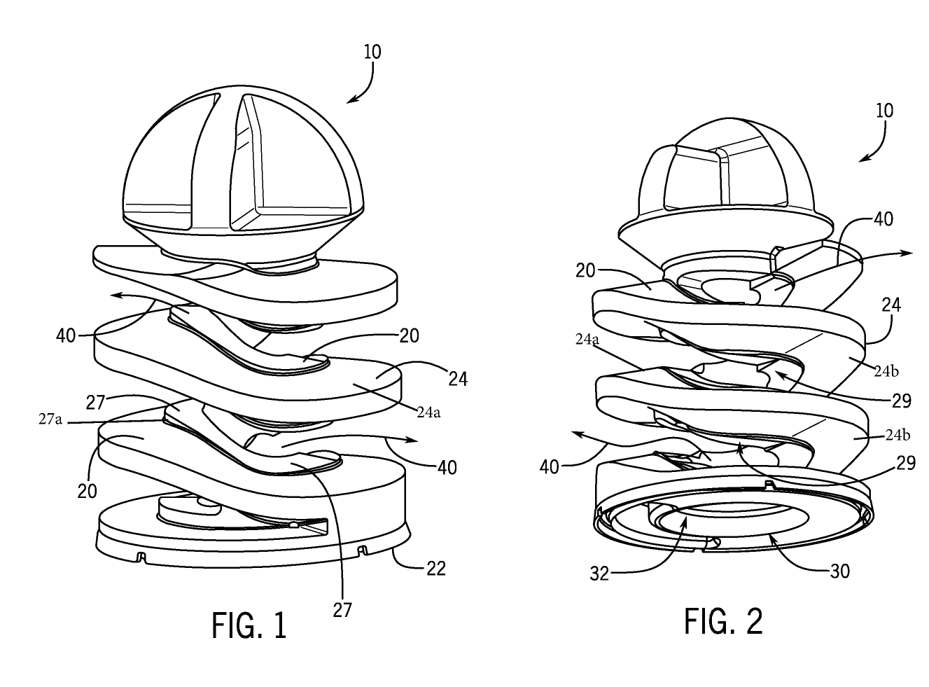

In some embodiments of the invention, in its natural relaxed unbiased state, the flow regulator can be in a longitudinally expanded state, with the spiral flow pathway open. In some embodiments, the flow pathway closes when the pressure of the flow on the flow regulator is sufficiently strong such that the flow regulator is forced into its contracted state. One advantage of the spiral shape of the flow regulator is that it can cause the water flowing through the supply tube to flow in a spiral manner. In some embodiments, this has the advantage of reducing the noise of the water passing through the supply tube and into the fill valve. Further details related to the above described embodiments are shown in FIGS. 1-9 and described below.

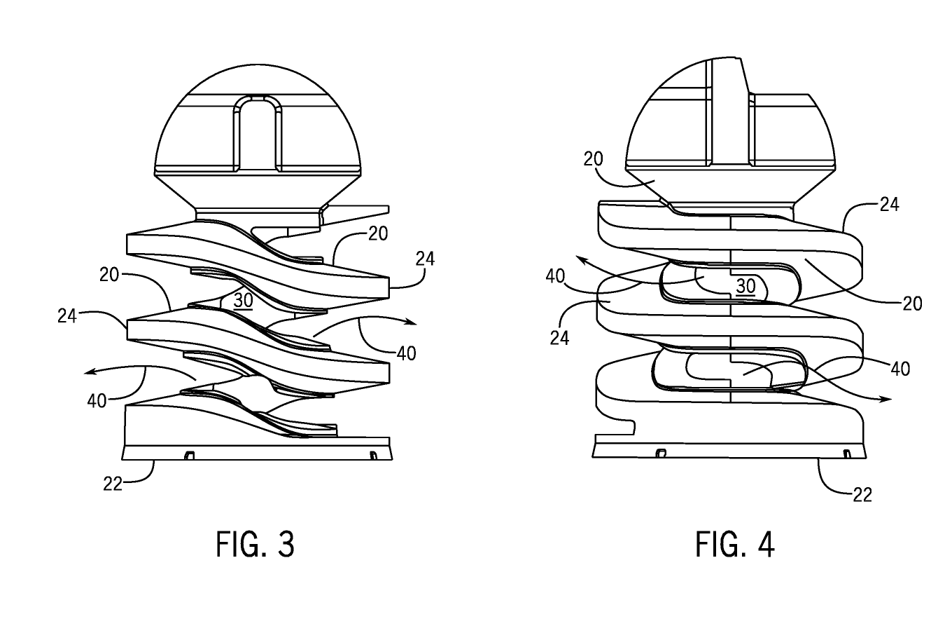

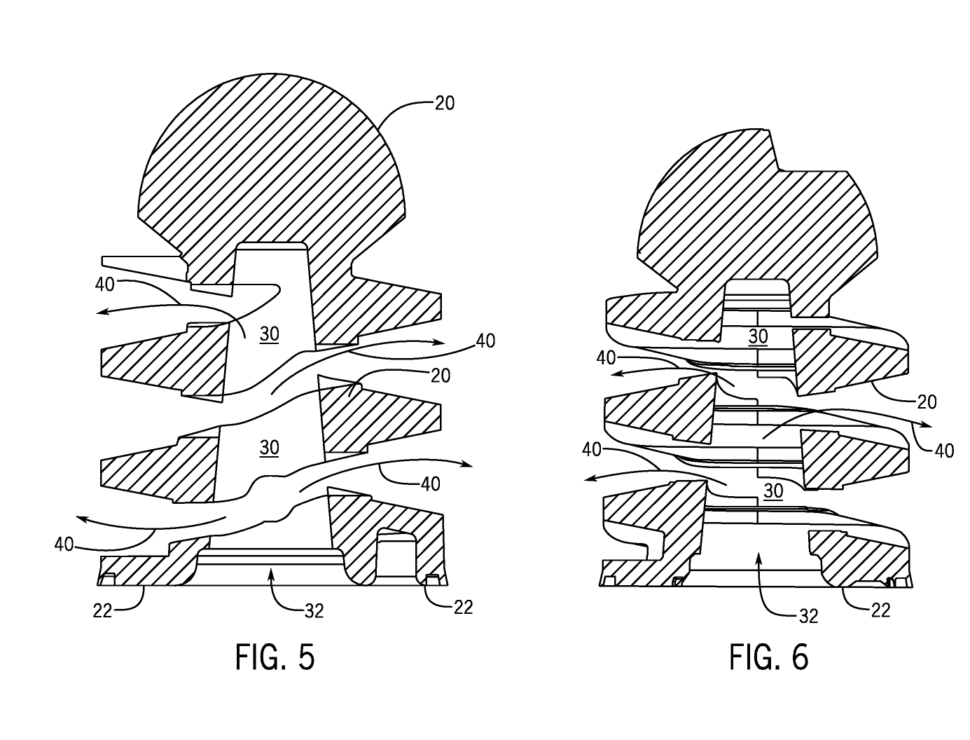

FIGS. 1 to 6 illustrate various view of a flow regulator 10 formed from an elongated spiral shaped body 20. For example, FIG. 1 is a top perspective view of a flow regulator 10 in accordance with some embodiments of the invention, and FIG. 2 is a bottom perspective view of the flow regulator of FIG. 1 in accordance with some embodiments of the invention. Further, FIG. 3 is a first side elevation view of the flow regulator of FIG. 1, and FIG. 4 is a second side elevation view of the flow regulator of FIG. 1, rotated by 90 degrees from the position shown in FIG. 3 in accordance with some embodiments of the invention. Further, FIG. 5 is a first sectional side elevation view of the flow regulator of FIG. 1 in accordance with some embodiments of the invention, and FIG. 6 is a second sectional side elevation view of the flow regulator of FIG. 1, rotated by 90 degrees from the position shown in FIG. 5 in accordance with some embodiments of the invention.

In some embodiments of the invention, the elongated spiral body 20 can be positioned at least partially wrapped around a central inner or internal chamber 30. In some embodiments, the internal chamber 30 can include an opening 32 at base 22 of the elongated spiral body 20. In some further embodiments, the flow regulator 10 can include an elongated spiral body 20 that comprises an outwardly extending vane 24 wrapping around at least a portion of the central internal chamber 30.

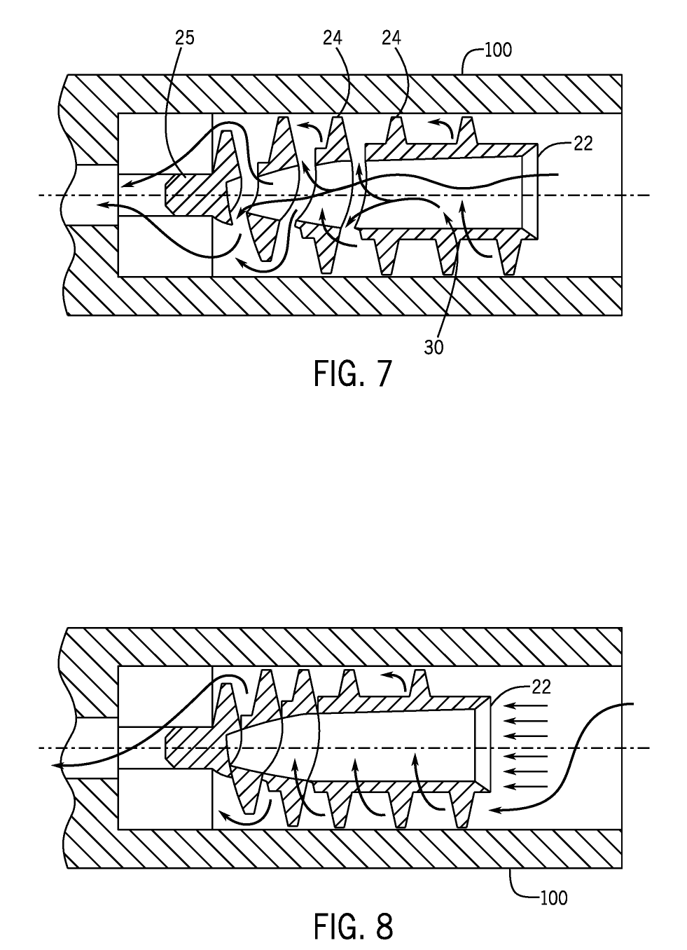

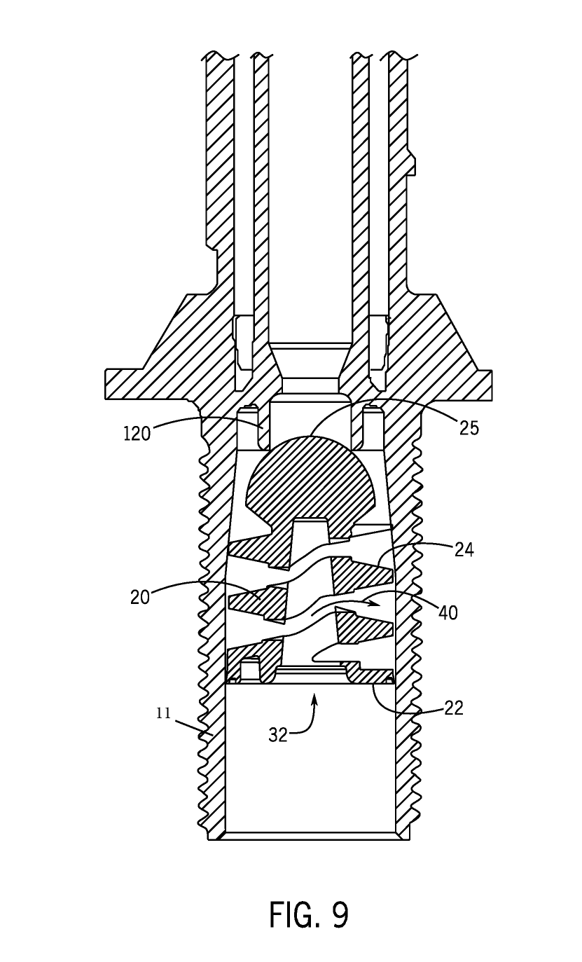

FIG. 7 is a sectional illustration of the flow regulator 10 of FIG. 1 in its relaxed open elongated state with the spiral flow pathway open in accordance with some embodiments of the invention, and FIG. 9 is a sectional illustration of the flow regulator 10 of FIG. 1 positioned in a supply tube for a fluid refill valve in accordance with some embodiments of the invention. In comparison, FIG. 8 is a sectional illustration of the flow regulator 10 of FIG. 1 in its compressed state with the spiral flow pathway closed in accordance with some embodiments of the invention. FIGS. 1 to 7 and 9 illustrate a non-limiting example embodiment of the elongated spiral body 20 in its natural, elongate state (e.g., at an atmospheric pressure of about 1.0 bar), whereas FIG. 8 illustrates a non-limiting embodiment of the elongated spiral body 20 in a compressed state. Thus, FIGS. 1 to 7 and 9 illustrate a natural state of the flow regulator where the flow regulator with a longitudinally extending spiral flow pathway 40 that opens in the elongated spiral body between the internal chamber 30 and the exterior of the elongated spiral body 20. FIG. 8 on the other hand illustrates a non-limiting embodiment of the flow regulator in a compressed state, where the spiral flow pathway 40 is closed. As can be seen, flow pathway 40 opens between adjacent portions of the outwardly extending vane 24. One of ordinary skill in the art can recognize that other embodiments include states that can be intermediary between those in FIGS. 1-7, and 9, and the state illustrated in FIG. 8, where the level of compression of the flow regulator 10 is such that the spiral flow pathway is partially closed or open.

FIGS. 7 and 8 illustrate the flow paths (depicted by arrows) through supply line 100 when spiral flow pathway 40 (shown in FIGS. 1-6) is opened (shown in FIG. 7) and closed (shown in FIG. 8). First, as seen in FIG. 7, spiral body 20 is in its natural relaxed state with flow pathway 40 open. Therefore, fluid passing through tube 100 (in the direction from base 22 to top end 25) passes both around spiral body 20 (moving in a spiral flow between adjacent vanes 24), and also exits from inner chamber 30 through open spiral flow pathway 40 between adjacent vanes 24). In some embodiments, the overall spiral motion of the fluid through tube 100 can decrease the noise made by the fluid flow. In addition, in some embodiments, the fluid passing thereover can comprise a relatively large flow path as it swirls spirally around regulator 10 and also passes out through flow pathway 40 from the center to the outside of the flow regulator.

However, in some embodiments, at higher fluid pressures as seen in FIG. 8, the higher pressure flow can push onto base 22, causing spiral body 20 to contract. As a result, in some embodiments, the spiral flow pathway 40 is closed in the contracted state shown in FIG. 8. In this state, all of the fluid passing through supply tube 100 flows in a spiral path around the spiral body 20, and not in the inner chamber 30. Stated another way, no fluid passes through spiral flow pathway 40 at high pressures. As a consequence, less fluid flow passes through supply tube 100 at higher pressures. In some embodiments, this has the advantage of reducing flow speed, and thereby reducing refill noise.

As described earlier, one of ordinary skill in the art can recognize that other embodiments include states that are intermediary between those in FIGS. 1-7, and 9, and the state illustrated in FIG. 8. Thus, it is to be appreciated that various intermediate states will occur (i.e.: states between the fully expanded state of FIG. 7 where flow pathway 40 is fully open, and the fully contracted state of FIG. 8 where flow pathway 40 is fully closed). Thus, an advantage of the embodiments of the flow regulator described herein are different flow profiles depending upon the pressure of the fluid flow to which it is subjected.

In some embodiments, (e.g., best seen in FIGS. 1 and 2), a top side of the outwardly extending vane 24 can include an inner edge portion 27 extending spirally around at least a portion of the inner chamber 30. Further, in some embodiments, the inner edge portion 27 can extend across a portion of the extending vane 24 from adjacent the inner chamber 30 radially outwards. In some embodiments, the inner edge portion 27 can follow a contour of at least a portion of the extending vane 24. Further, in some embodiments, at least a portion of the inner edge portion 27 can extend from the upper surface 24a of the extending vane 24, thereby defining a thickness 27a of the inner edge portion 27 as shown. In some embodiments, at least a portion of the inner edge portion 27 can extend a variable thickness from the surface of the extending vane 24, thereby defining a thickness 27a of the inner edge portion 27 that varies in distance extending from the upper surface 24a.

Some embodiments include a recess 29 in a portion of the extending vane 24. In some embodiments, at least a portion of the recess 29 can follow a contour of at least a portion of the extending vane 24. In some embodiments of the invention, based at least in part on a fluid flow pressure exerted on a portion of the spiral body 20, at least a portion of the inner edge portion 27 can be received into the recess 29 in the bottom side 24b of the outwardly extending vane 24 of the elongated spiral body 20. For example, in some embodiments of the invention, at least a portion of the inner edge portion 27 can be received into a recess 29 in the bottom side 24b of the outwardly extending vane 24 when the elongated spiral body 20 is longitudinally contracted (such as depicted FIG. 8). In some embodiments, when the spiral body 20 includes a flow pathway 40 that is at least partially open, at least a portion of the inner edge portion 27 can be at least partially separated from the recess 29, and thus allowing fluid passing through tube 100 (in the direction from base 22 to top end 25) to pass both around spiral body 20 (moving in a spiral flow between adjacent vanes 24), and also exiting from inner chamber 30 through open spiral flow pathway 40 between adjacent vanes 24 between a space separating the inner edge portion and the recess 29). In some further embodiments, when the spiral flow pathway 40 has been closed, partially closed, and/or in the contracted state (shown in FIG. 8), most or all fluid passing through supply tube 100 can flow in a spiral path around the spiral body 20, and not in the inner chamber 30 (as little or no fluid can pass between a region closed or partially closed between the inner edge portion 27 and the recess 29.

In some embodiments of the invention, the spiral body 20 can include additional structures that can function to support one or more portions of the spiral body 20, and can be used to handle or position the flow regulator 10, or can channel or otherwise affect fluid flow. For example, FIG. 9 is a sectional illustration of the flow regulator 10 of FIG. 1 positioned in a supply tube 100 for a fluid refill valve in accordance with some embodiments of the invention. In some embodiments, spiral body 20 can include a top end 25 that can be positioned against or coupled to a portion of the supply tube 100 or other structure coupled to the supply tube 100. In some embodiments, the top end 25 of spiral body 20 may be rounded or curved as shown in the non-limited embodiments disclosure in FIG. 9, as well as in FIGS. 1-8. In some embodiments, at least a portion of the top end 25 of spiral body 20 can receive, couple to, or rest-against support 120 as depicted.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A flow regulator, comprising:
a main body dimensioned to be received within a flow passageway, the main body including at least one inlet and at least one adjustable outlet;
an inner chamber positioned at least partially within the main body and extending from at least proximate the at least one inlet of the main body along at least a partial length of the main body, the at least one inlet being positioned as an upstream section;
a compressible or expandable extending vane extending from the main body and extending around at least a portion of the inner chamber; and
an adjustable fluid flow space extending around or over at least a portion of the extended vane, the fluid flow space configured to receive at least some fluid from at least a portion of the flow passageway, wherein the fluid comprises a fluid flow rate and a fluid pressure.

2. The flow regulator of claim 1, wherein the inner chamber is positioned substantially in the center of the main body, and the at least one inlet is positioned at a base of the main body.

3. The flow regulator of claim 1, wherein the extending vane extends outwardly from the inner chamber, and is longitudinally expandable or compressible based at least in part on the fluid pressure.

4. The flow regulator of claim 1, wherein the adjustable fluid flow space is configurable to at least partially include or exclude a flow pathway from within at least a portion of the inner chamber based at least in part on the fluid pressure.

5. The flow regulator of claim 1, wherein the main body comprises an adjustable spiral wrapping around at least a portion of the inner chamber, the adjustable spiral including the compressible or expandable extending vane.

6. The flow regulator of claim 4, wherein the inclusion or exclusion of the flow pathway is based at least in part on a state of expansion or compression of the extending vane, the expansion or compression of the extending vane being dependent at least in part on the fluid pressure.

7. The flow regulator of claim 1, wherein the extending vane comprises an inner edge portion extending from an upper surface of the extending vane, and extending generally in a spiral shape around at least a portion of the inner chamber.

8. The flow regulator of claim 7, wherein the inner edge portion extends across a portion of the extending vane from adjacent the inner chamber radially outwards.

9. The flow regulator of claim 7, wherein the extending vane further comprises a recess following a contour of at least a portion of the extending vane on a lower surface opposite the upper surface.

10. The flow regulator of claim 9, wherein based at least in part on the fluid pressure exerted on a portion of the main body, at least a portion of the inner edge portion is configured to be received into or out of the recess.

11. The flow regulator of claim 9, wherein based at least in part on the fluid pressure exerted on a portion of the main body, the adjustable fluid flow space at least partially includes a fluid flow through the inner chamber when the inner edge portion is positioned at least partially out of the recess.

12. The flow regulator of claim 9, wherein based at least in part on the fluid pressure exerted on a portion of the main body, the adjustable fluid flow space at least partially excludes a fluid flow through the inner chamber when the inner edge portion is positioned at least partially in the recess.

13. The flow regulator of claim 1, wherein the fluid flow space is configured and arranged to change based on the fluid pressure, the fluid pressure contributing to a movement of at least a portion of the main body including movement of the extending vane.

14. The flow regulator of claim 1, wherein at least one of the main body and extending vane comprises a flexible polymer, wherein at least a portion of the main body or extending vane is configured to exhibit flexing movement based at least in part on the fluid pressure.

15. The flow regulator of claim 1, wherein the at least one adjustable outlet is configured to adjust the fluid flow rate in a downstream section of the flow passageway based at least in part on the fluid pressure experienced by the main body, wherein the fluid flow rate adjustment includes a holding substantially constant or decrease in flow rate in the downstream section based at least in part on an increase in the flow pressure in the upstream section, and wherein an increase in flow pressure produces movement of the extending vane and at least partial closure of the at least one adjustable outlet between the inner chamber and the adjustable fluid flow space.

16. A flow system comprising:
at least one adjustable fluid outlet extending through an inner chamber of a main body;
an adjustable fluid flow space extending around at least a portion of the inner chamber, the adjustable fluid flow space being reversible coupled to the inner chamber; and
a compressible or expandable extending vane extending from the main body and wrapping around at least a portion of the inner chamber, wherein the adjustable fluid flow space is configured to enable a fluid flow extending around or over at least a portion of the extended vane, and
wherein based on a fluid pressure, the fluid flow is configured to receive fluid from the inner chamber when the at least one adjustable fluid outlet is fluidly coupled to the inner chamber.

17. The flow system of claim 16, wherein the at least one adjustable fluid outlet is configured to adjust the fluid flow rate in a downstream section of a flow passageway based at least in part on the fluid pressure, wherein the fluid flow rate adjustment includes a holding substantially constant or decrease in flow rate in the downstream section based at least in part on an increase in the flow pressure in an upstream section, and
wherein an increase in flow pressure produces movement of the extending vane and at least partial closure of the at least one adjustable fluid outlet.

18. The flow system of claim 16, wherein the extending vane comprises an inner edge portion extending from an upper surface of the extending vane, and extending spirally around at least a portion of the inner chamber.

19. The flow system of claim 18, wherein the inner edge portion extends across a portion of the extending vane from adjacent the inner chamber radially outwards.

20. The flow system of claim 18, wherein the extending vane further comprises a recess positioned on a lower surface opposite the upper surface, wherein based at least in part on the fluid pressure, at least a portion of the inner edge portion is configured to be received into or out of the recess.
